(19) United States
(12) Patent Application Publication
(10) Pub. No.: US 2008/0284835 A1
(43) Pub. Date: Nov. 20, 2008

(54) INTEGRAL, MICROMACHINED GUTTER FOR INKJET PRINTHEAD

(76) Inventors: Hrishikesh V. Panchawagh, Rochester, NY (US); Constantine N. Anagnostopoulos, Mendon, NY (US); Joseph E. Yokajty, Webster, NY (US); Joseph Jech, JR., Webster, NY (US)

Correspondence Address: Patent Legal Staff;Eastman Kodak Company, 343 State Street, Rochester, NY, 14650-2201, US

(21) Appl. No.: 11/748,663

(22) Filed: May 15, 2007

(51) Int. Cl. B41J 2/185

(52) U.S. Cl. 347/90

(57) ABSTRACT

The invention provides an ink jet printhead comprising a monolithic printhead with an integral gutter system wherein said gutter system is provided with an end wall adjacent to the ink stream and wherein the side of the wall adjacent the ink direction is generally parallel to the ink direction through said print head.

### FIELD OF THE INVENTION

This invention relates to the field of inkjet printing heads. The invention particularly relates to inkjet printheads with improved gutters.

### BACKGROUND OF THE INVENTION

U.S. Pat. No. 6,079,821 issued to Chwalek et al. discloses a continuous ink jet printhead in which deflection of selected droplets is accomplished by asymmetric heating of the jet exiting the orifice.

U.S. Pat. No. 6,554,410 by Jeanmaire et al. teaches an improved method of deflecting the selected droplets. This method involves breaking up each jet into small and large drops and creating an air or gas cross flow relative to the direction of the flight of the drops that causes the small drops to deflect into a gutter or ink catcher while the large ones bypass it and land on the medium to write the desired image or the reverse, that is, the large drops are caught by the gutter and the small ones reach the medium.

U.S. Pat. No. 6,450,619 to Anagnostopoulos et al. discloses a method of fabricating nozzle plates, using CMOS and MEMS technologies which can be used in the above printhead. Further, in U.S. Pat. No. 6,663,221, issued to Anagnostopoulos et al, methods are disclosed of fabricating page wide nozzle plates, whereby page wide means nozzle plates that are about 4 inches long and longer. A nozzle plate, as defined here, consists of an array of nozzles and each nozzle has an exit orifice around which, and in close proximity, is a heater. Logic circuits addressing each heater and drivers to provide current to the heater may be located on the same substrate as the heater or may be external to it.

For a complete continuous ink jet printhead, besides the nozzle plate and its associated electronics, a means to deflect the selected droplets is required, an ink gutter or catcher to collect the unselected droplets, an ink recirculation or disposal system, various air and ink filters, ink and air supply means and other mounting and aligning hardware are needed.

In these continuous ink jet printheads the nozzles in the nozzle plates are arranged in a straight line, they are between about 150 to 2400 per inch and, depending on the exit orifice diameter, can produce droplets as large as about 100 Pico liters and as small as 1 Pico liter.

As already mentioned, all continuous ink jet printheads, including those that depend on electrostatic deflection of the selected droplets (see for example U.S. Pat. No. 5,475,409 issued to Simon et al), an ink gutter or catcher is needed to collect the unselected droplets. Such a gutter has to be carefully aligned relative to the nozzle array since the angular separation between the selected and unselected droplets is, typically, only a few degrees. The alignment process is typically a very laborious procedure and increases substantially the cost of the printhead. The printhead cost is also increased because each gutter must be aligned to its corresponding nozzle plate individually and one at a time.

The gutter or catcher may contain a knife-edge or some other type of edge to collect the unselected droplets, and that edge has to be straight to within a few tens of microns from one end to the other. Gutters are typically made of materials that are different from the nozzle plate and as such they have different thermal coefficients of expansion so that if the ambient temperature changes the gutter and nozzle array can be in enough misalignment to cause the printhead to fail. Since the gutter is typically attached to some frame using alignment screws, the alignment can be lost if the printhead assembly is subjected to shock as can happen during shipment. If the gutter is attached to the frame using an adhesive, misalignment can occur during the curing of the glue as it hardens, resulting in yield loss of printheads during their assembly.

The U.S. publication 2006/0197810 A1-Anagnostopoulos et al. discloses an integral printhead member containing a row of inkjet orifices.

There is a need for an effective gutter arrangement for a monolithic printhead that can be formed from micromachined silicon wafers combined to form a printhead.

### SUMMARY OF THE INVENTION

An object of this invention is to overcome disadvantages of the prior art.

A further object of the invention is to provide high quality continuous inkjet print quality.

A further object in the invention is to provide an improved integral printhead.

The invention provides an ink jet printhead comprising a monolithic printhead with an integral gutter system wherein said gutter system is provided with an end wall adjacent to the ink stream and wherein the side of the wall adjacent the ink direction is generally parallel to the ink direction through said print head.

### BRIEF DESCRIPTION OF THE DRAWINGS

FIG. 1 is a cross-sectional view of an ink jet printhead using the gutter wall of the invention.

FIG. 2 is a schematic view of a continuous ink jet printer.

FIG. 3 is an enlarged schematic view of a gutter for an ink jet invention.

FIG. 4 is a schematic side view of the gutter printhead of the gutter.

FIG. 5 is a view of a silicon wafer comprising several printheads.

FIGS. 6A-6H are views of an etching of a silicon wafer.

FIG. 6I is an illustration of combining silicon wafers to make an integral gutter printhead.

FIG. 7 is a top view of a gutter with grooves.

FIG. 8 is a top view of a gutter with inside wall grooves.

FIG. 9 is a top view of a gutter with outside wall grooves.

FIG. 10 is top view of a gutter with inside and outside wall grooves.

FIG. 11 is a top view of a gutter with shaped ribs.

FIG. 12 is a perspective view of a gutter with shaped ribs.

FIGS. 13 and 14 are views of a gutter with ribs extending to the wall.

### DETAILED DESCRIPTION OF THE INVENTION

The invention provides numerous advantages over prior practices. The monolithic integral printhead of the invention provides improved separation of non-selected drops from the selected drops. In the printhead of the invention non-selected drops are more likely to reach the gutter. In one embodiment of the invention the non-selected drops are drawn into the gutter even if they hit the exterior of the wall. The gutter wall of the invention allows forming from silicon wafers as the design does not require formation of a knife edge or angled catcher for drops. The design of the invention may be formed with typical silicon etching techniques such as the deep reactive ion etching (DRIE) technique. These and other advantages of the invention will become apparent from the detailed description below.

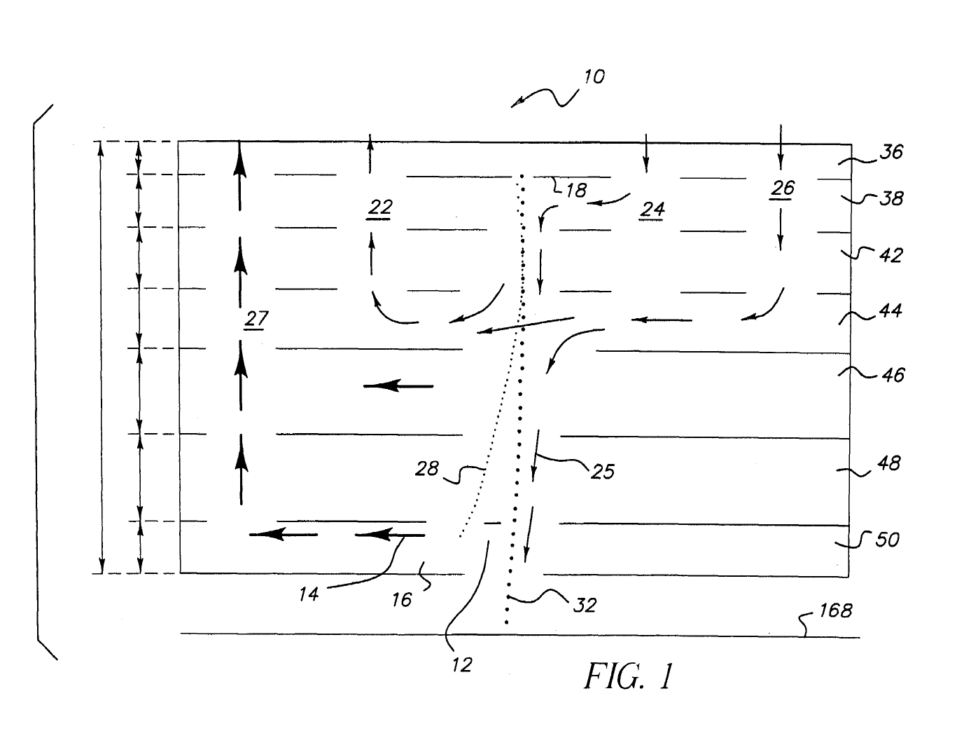

In FIG. 1 is illustrated a monolithic integral gutter printhead that can have a gutter with a wall 12 of the invention. The integral printhead is provided with duct openings 26 for deflection air entering into the printhead and suction to remove the deflection air at 22. The printhead also has a duct opening at 24 for collinear air to enter the printhead and to be removed into duct 22. A portion of deflection air entering through openings 26 exits through opening 25 to provide collinear air post deflection. The ink orifice of the nozzle array 18 emits continuous streams of ink droplets. The droplets are separated into streams of small droplets 28 and large droplets 32 by the deflection air entering at 26. The printhead as shown is formed of seven layers of silicon material. The layers are the nozzle plate 36, followed by plates 38, 42, 44, 46, 48, and 50. In one example embodiment, the plate 36 is about 300 μm thick, layer 38 is about 450 μm thick, silicon layer 42 is 450 μm thick, silicon layer 44 is 450 μm thick, silicon layer 46 is 650 μm thick, layer 48 is 650 μm thick and the gutter layer 50 is 450 μm thick. However, these dimensions will vary depending on the specific application contemplated. For example, these dimensions may vary depending on the specific nozzle design, type of ink being ejected, etc. The individual layers have been combined into a monolithic integral gutter unit after individual etching to form structures and holes in each individual plate or wafer. Of particular interest is the gutter plate 50 where the wall 12 has been formed integral with that layer as the etching technique utilized allowed the formation of a very narrow wall. The gutter duct 14 generally has a height of between about 100 and 300 μm to provide improved capillary flow. The small droplet ink 28 is collected in the gutter duct 14 and withdrawn by suction through duct 27.

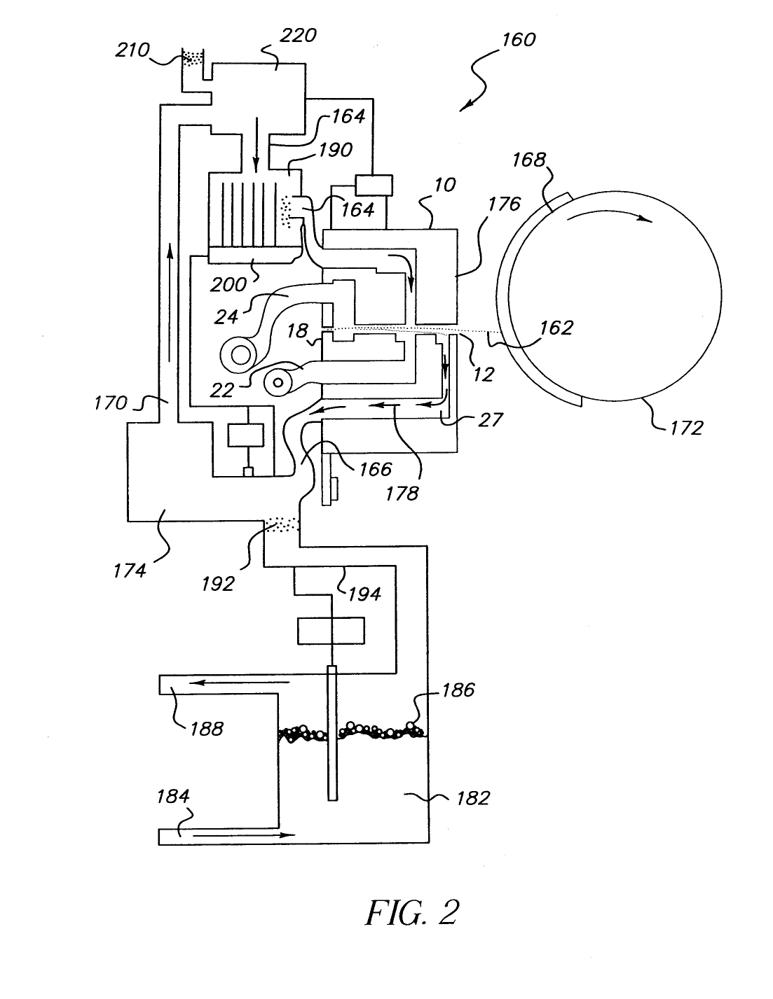

Referring to FIGS. 1 and 2, a printing apparatus (typically, an ink jet printer or printhead) used in a preferred implementation of the current invention is shown schematically. The printer 160 includes an integral deflector gutter wall 12 that has been integrally formed as a part of the ink-jet nozzle array 18. Large volume ink droplets 32 and small volume ink droplets 28 are formed from ink ejected from the ink droplet forming mechanism/printhead 10 substantially along ejection stream path 162. The integral gutter structure 166 includes an inlet plenum 164 and an outlet plenum 166 for directing a gas through integral deflector gutter structure and against the ink droplets for separating the different size ink droplets. The integral gutter includes a thin wall 12 that is positioned adjacent to the outer edge of the gutter 16. The purpose of wall 12 is to intercept the displaced small droplets 28, while allowing large ink droplets 32 traveling along droplet path 162 to continue on to the recording medium 168 carried by print drum 172. Vacuum pump 174 communicates with ink recovery conduit 166 and provides a sink for the gas flow 178. The application of force due to gas flow 176 separates the ink droplets into small-drop path and a large drop path. Pump 220 draws in air, while filter 210 removes dust and dirt particles.

An ink recovery duct 27 is connected to outlet plenum 166 of integral wall gutter structure 16 for receiving droplets recovered by deflector 12. Ink recovery conduit 27 communicates with ink recovery reservoir 182 to facilitate recovery of non-printed ink droplets by an ink return line 184 for subsequent reuse. The ink recovery reservoir 182 contains open-cell sponge or foam 186, which prevents ink sloshing in applications where the nozzle array 18 is rapidly scanned. A vacuum conduit 188, coupled to a negative pressure source, can communicate with ink recovery reservoir 182 to create a negative pressure in ink recovery conduit 166 improving ink droplet separation and ink droplet removal. The gas flow rate in ink recovery conduit 166, however, is chosen so as to not significantly perturb the large droplet path. The ink recovery conduit 166 is fitted with filter 192 and drain 194 to capture any ink fluid resulting from ink misting, or misdirected jets which has been captured by the air flow in plenum 166. Captured ink is then returned to recovery reservoir.

Additionally, a portion of inlet plenum 164 diverts a small fraction of the gas flow from pump 220 and conditioning chamber 190 to provide a source for the gas which is drawn into ink recovery conduit 166 and into gas recycling line 170. The gas pressure at gutter wall 12 and in ink recovery conduit 166 are adjusted in combination with the design of ink recovery conduit 166 and plenum 164 so that the gas pressure in the printhead assembly near integral gutter 16 is positive with respect to the ambient air pressure near print drum. Environmental dust and paper fibers are thusly discouraged from approaching and adhering to integral wall 12 and are additionally excluded from entering ink recovery conduit 166.

In operation, a recording medium 168 is transported in a direction to transverse to axis 162 by print drum 72 in a known manner. Transport of recording medium 168 is coordinated with movement of printhead/nozzle array mechanism, not shown, for controlling drop size. This can be accomplished using controller not shown in a known manner. Recording media 168 may be selected from a wide variety of materials including paper, vinyl, cloth, other fibrous materials, etc.

The recovery air duct 27 of integral gutter structure 16 is integrally formed to nozzle array 18. In the preferred embodiment, an orifice cleaning system, not shown, may also be incorporated into collinear air structure duct 24. Cleaning would be accomplished by flooding the nozzle array 18 with solvent injected through structure 24. Used solvent is removed by drawing vacuum on the cleaning solvent through output port 242.

In the present invention the guttering structure is integrally formed with nozzle array 18. This is done in order to maintain accuracy between the ink jet nozzles 18 and the wall 12. In a preferred embodiment of the present invention, nozzle array 18 is formed from a semiconductor material (silicon, etc.) using known semiconductor fabrication techniques (CMOS circuit fabrication techniques, micro-electro mechanical structure (MEMS) fabrication techniques, etc.). Such techniques are illustrated in U.S. Pat. Nos. 6,663,221 and 6,450,619 which are hereby incorporated by reference in their entirety. However, it is specifically contemplated and therefore within the scope of this disclosure that nozzle array may be integrally formed with the gutter structure from any materials using any fabrication techniques conventionally known in the art.

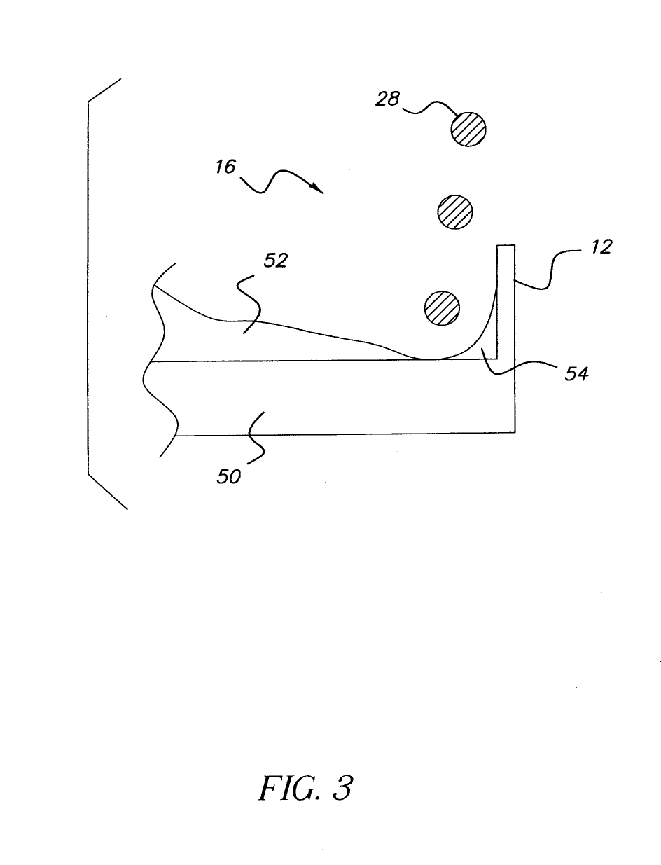

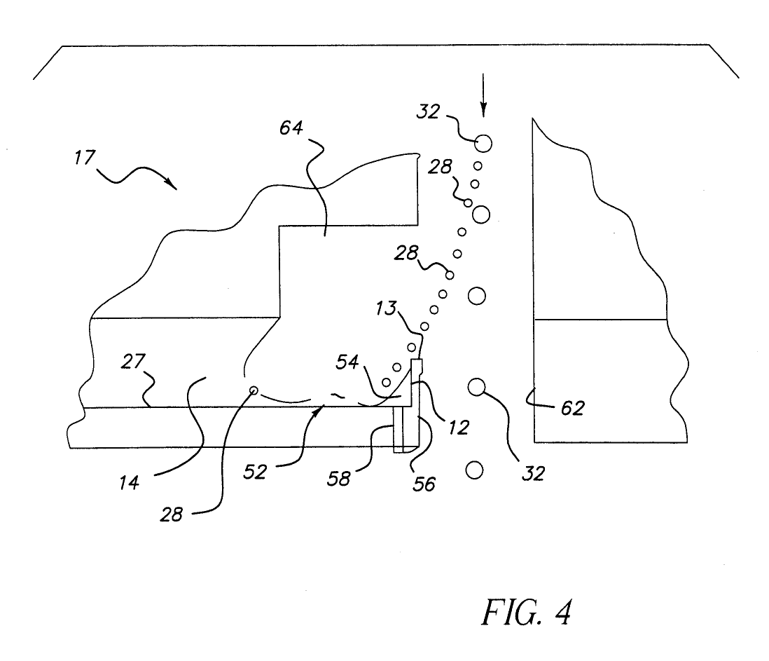

FIG. 3 is an enlarged view of wall 12 and gutter 16 in accordance with the invention. The small drops 28 to be recovered are received inside the wall 12. The received drops form a meniscus 54 against the wall 12. The ink then flows along at 52 to where it will be withdrawn from the printhead. The wall 12 is very narrow and is of an integral piece with the base of the plate 50. In FIG. 4 is another enlarged view of gutter 17 with wall 12 of the invention. Gutter 17 is provided with a recovery hole 58 to recover small ink drops 28 that have mistakenly hit the exterior 56 of wall 12. The drops after hitting the wall run down beneath the gutter where the they may be withdrawn into the recovery hole 58 by the action of the suction and capillary forces in recovery duct 27 which withdraws the ink for recovery. It is possible that the exterior of the wall may be provided with capillary channels to aid in the movement of the ink toward the recovery hole on the bottom of the gutter. It is understood that there would be a series of recovery holes below the nozzle array in a silicon structure containing an array of nozzles. The number of ink recovery holes would generally correspond to the number of nozzles. The opening notch 64 has been formed in order to allow earlier withdrawal of small drops 28 from the stream. The opening notch 64 allows the small drops 28 to be moved to exit the main bore 62 and leave the flow of air in the bore at an earlier point, in the flow of the collinear air and large drops 32 towards the exit of the bore 62. Wall 12 includes a top surface 13.

The integral guttered device of the invention may be formed by any of the known techniques for shaping silicon articles. These include CMOS circuit fabrication techniques, microelectrical mechanical structure fabrication techniques(MEMS) and others. The preferred technique has been found to be the deep reactive ion etch (DRIE) process. Because this process enables fabrication of high aspect ration structures with large etch depths deep (>10 micrometers) required for this device in comparison with other silicon formation techniques. The techniques for creation of silicon materials involving etching several silicon wafers which are then united in an extremely accurate manner is particularly desirable for formation of print heads as the distance is between the nozzles of the print heads must be accurately controlled. Further there is need to but channels for fluid and air handling into the silicon structure in an accurate manner.

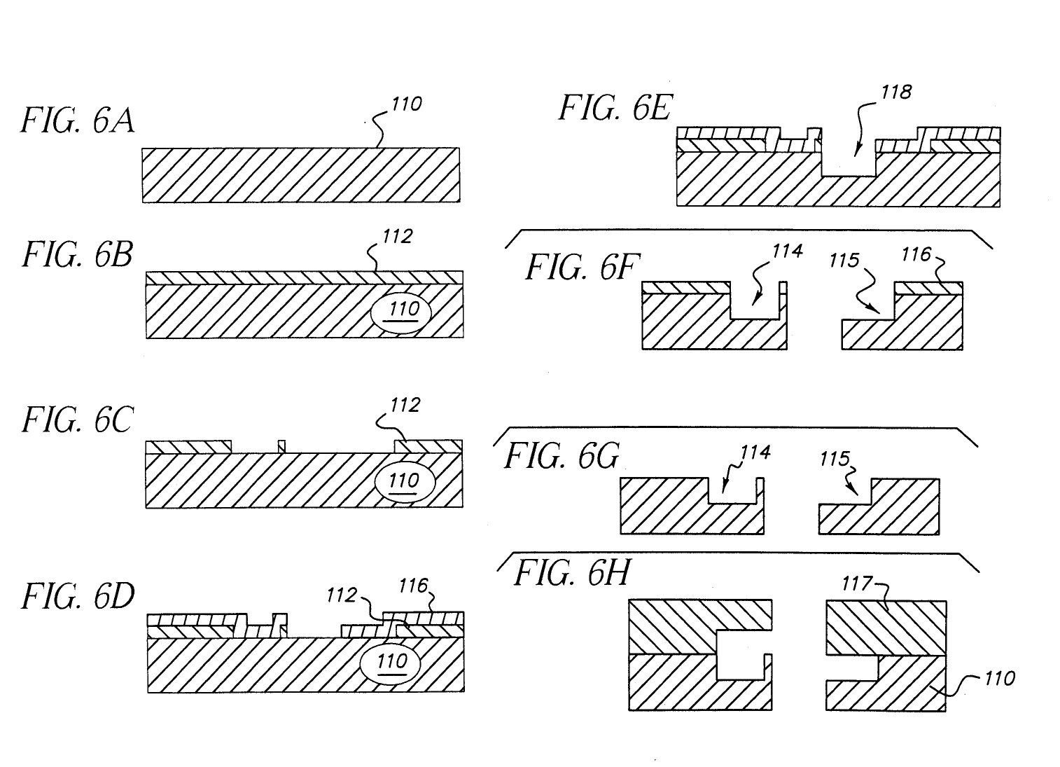

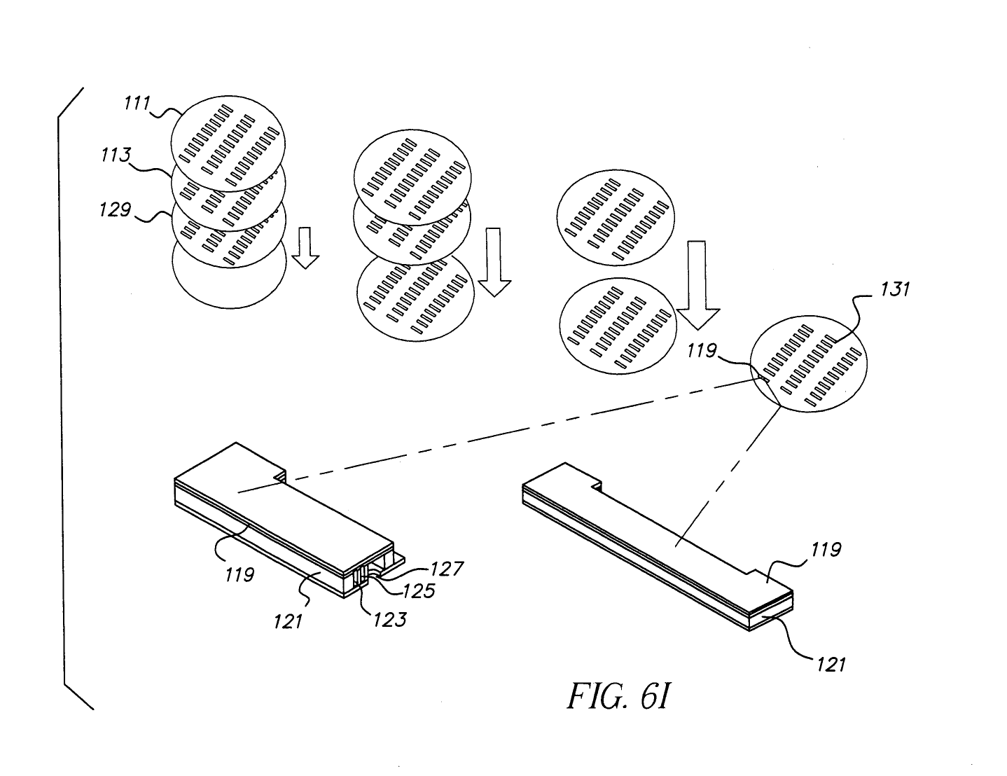

The methods and apparatus for formation of stacked chip materials are well-known. In FIGS. 6A-6I there is given a brief illustration of the manufacturing process. In FIG. 6A there is shown a single wafer 110 that has no features etched into the silicon. In FIG. 6B there has been deposited a layer of plasma enhanced chemical vapor deposited (PECVD) silicon dioxide film 112 has been deposited on the wafer. In FIG. 6C the oxide layer has been patterned using photolithography to define partially etched areas. In FIG. 6D. The surface has been coated with a pattern of photoresist 116 on the side to be etched to define the opening in the photoresist where etching is to take place. In FIG. 6E the wafer 110 has been partially etched utilizing deep reactive ion etch process using the photoresist mask. In FIG. 6F after further etching has been carried out using oxide hard mask, there is formed a hole 115 through the wafer as well as removed part of the wafer at 114. In FIG. 6G the oxide film has been removed to recover a formed wafer that will be one layer of a monolithic structure. In FIG. 6H another wafer 117 is bonded to wafer 110. Silicon wafer 117 as already been etched by the same process. In FIG. 6I there is a prospective expanded view of the fabrication of an integral gutter device via wafer scale integration. As illustrated there are etched wafers 111, 113, and 115 that are joined to form wafer 117 that is a monolithic structure wherein openings have been formed by the individual etchings in the separate wafers 111, 113, and 115. The printhead 119 is then fastened to manifold 121. It can be seen that manifold 121 has openings 123 and 125 which would be channels for air in and out to be supplied to the printhead. Opening 127 would be an orifice in the manifold to bring fluids to the manifold or to provide suction. It is noted that FIG. 6I is only illustrative. The printhead of the invention as shown in FIG. 1 would generally require at least six layers of plates or wafers with etching to form the needed channels for the integral gutter wall silicon printhead.

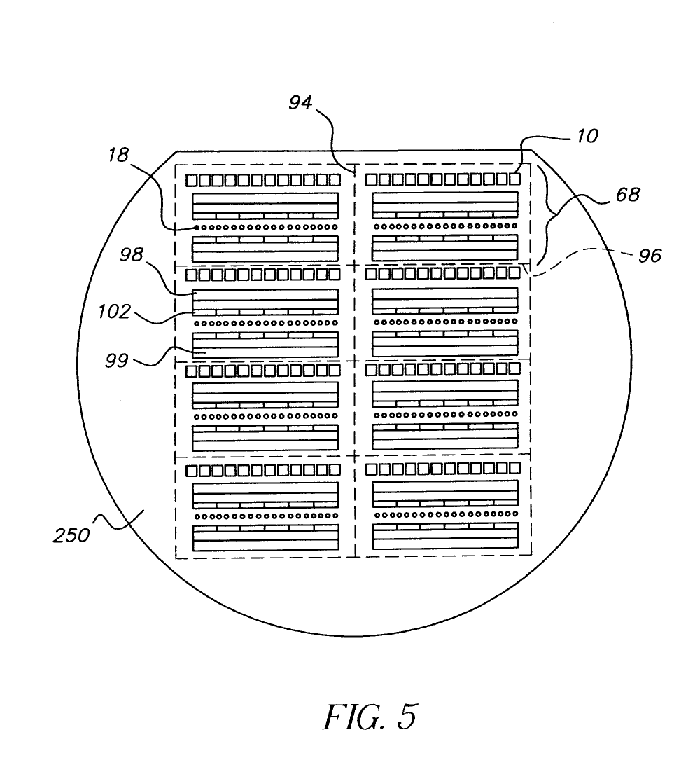

In FIG. 5 there is representation of 8 integral gutter devices on a single silicon wafer stack 250. Bracket 63 indicates a single device that may be separated from the stack on lines 94 and 96. The wafer stack containing the printheads are presented in the drawings in such a manner that the rows of the nozzle array 18 are exposed. The other parts of the wafer 90 are within the chip but indicated on the schematic representation. Channels 98 represents the channels for the collinear air to go in and for the cleaning solvent to go in and out. Ink returns 99 provide a path from the gutter to the ink supply not shown. The channels for the deflection air to go in to the wafer are indicated by 102.

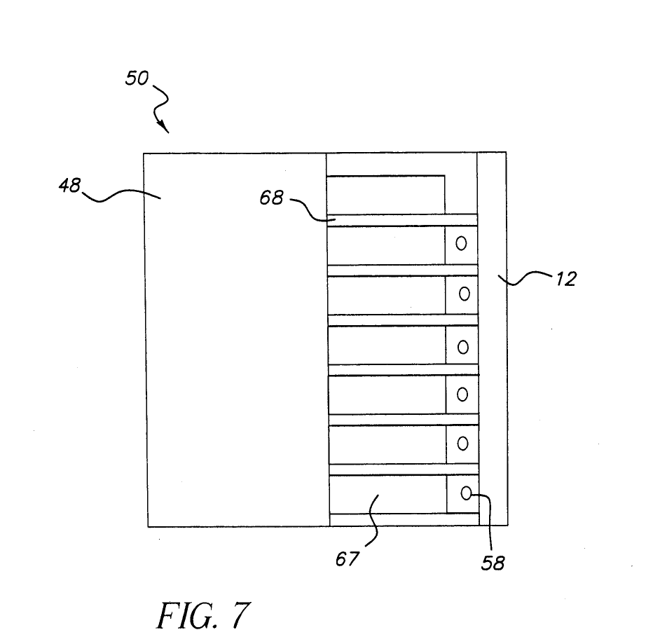

FIGS. 7, 8, 9, and 10 are overhead schematic views of gutters of the invention illustrating various gutter embodiments that may be used. FIG. 7 illustrates a gutter 50 with ribs 68. The spacing of the ribs generally corresponds to the spacing between nozzles although the ribs may be spaced such that there is more than one nozzle between each pair of ribs. The gutter of FIG. 7 is provided with the ink recovery holes 58. The ribs 68 are shown as extending to the wall. However it is possible that the ribs could only extend to the area of the holes 58. One advantage of ribs 68 is that the channels 67 withdrawing ink from the area where the ink drops impact are smaller thereby having capillary forces aiding withdrawal. The ribs also aid in the control of splashing of the drops as they hit into the gutter.

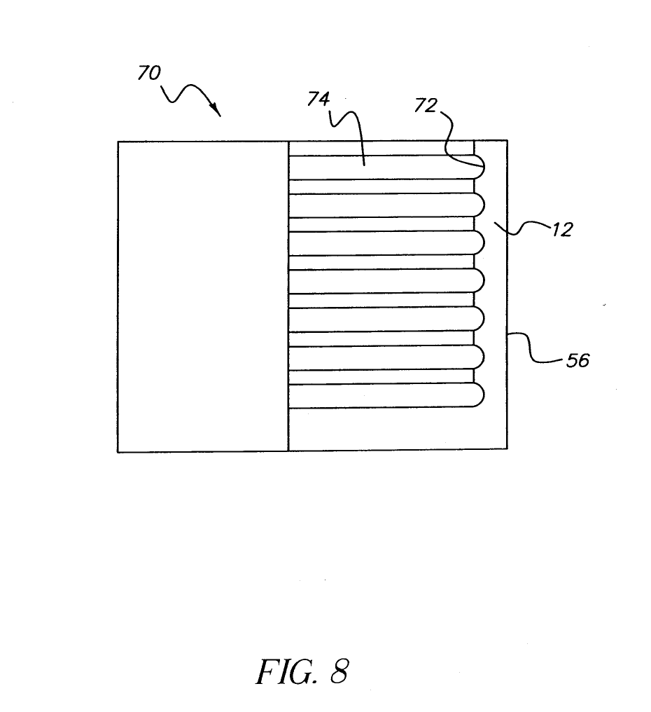

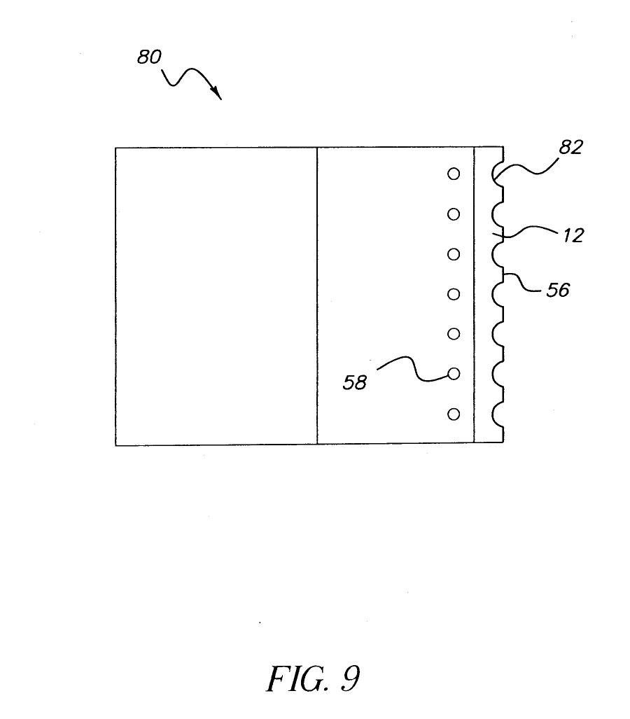

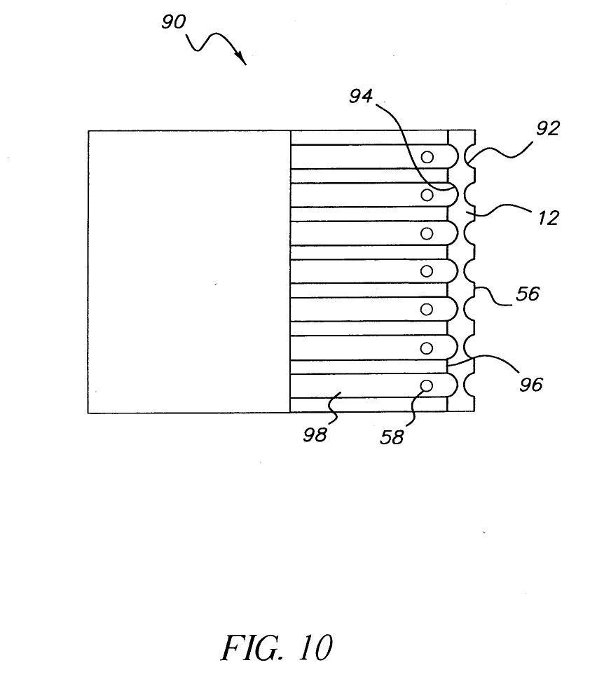

FIG. 8 shows a portion of a gutter 70 that is provided with indentations in the wall 12. The indentations 72 are preferably of capillary size and aid in the draining of ink from the inside of the wall 12. The bottom of the gutter is also provided with capillary channels 74 which aid in movement of ink into the ink withdrawal channel not shown. In FIG. 9 there is shown a portion of a gutter arrangement 80 in which the outside 56 of wall 12 has been provided with capillary channels 82. These capillary channels 82 aid in movement of ink that hits the outside of the wall 56 to the bottom of the gutter where it is withdrawn through ink recovery holes 58.

In FIG. 10 there is shown another embodiment of a gutter 90 of the instant invention. The embodiment 90 is a partial view of an inkjet gutter wherein the wall 12 is provided with grooved capillary openings 94 on the inside of wall 12 and capillary grooves 92 the outside surface 56 of the wall 12. The gutter 16 is further provided with capillary grooves 98 in the bottom of the gutter such that ink is drawn it into the recovery channel, not shown. The capillary grooves 98 are shown as corresponding with capillary grooves 94 on the inside of the wall 12, but in some embodiments the capillaries would not be required to correspond to each other. This wall 12 with openings 94 and 92 on both the inside 96 and the outside 56 results in channeling of ink to be recovered, below the wall through recovery holes 58 and in channeling of ink with the aid of capillaries 98 and 94 to the recovery channel not shown.

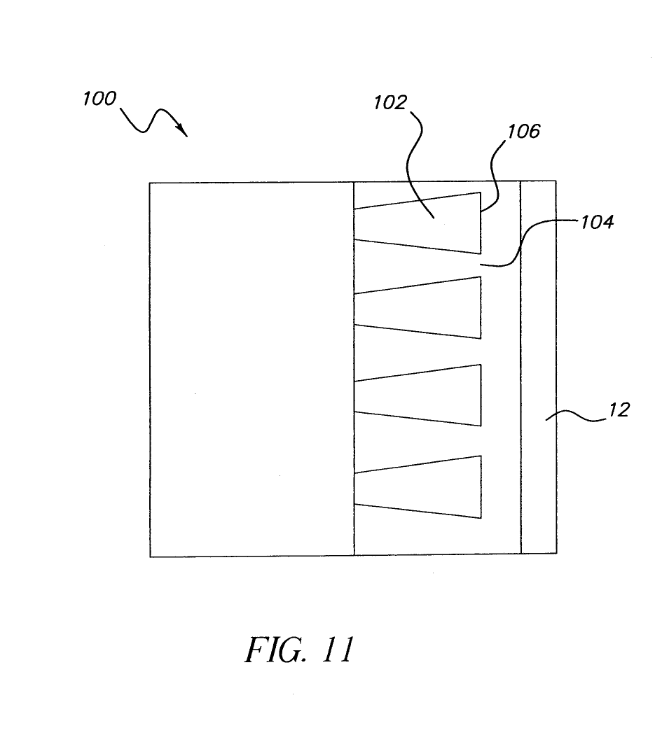

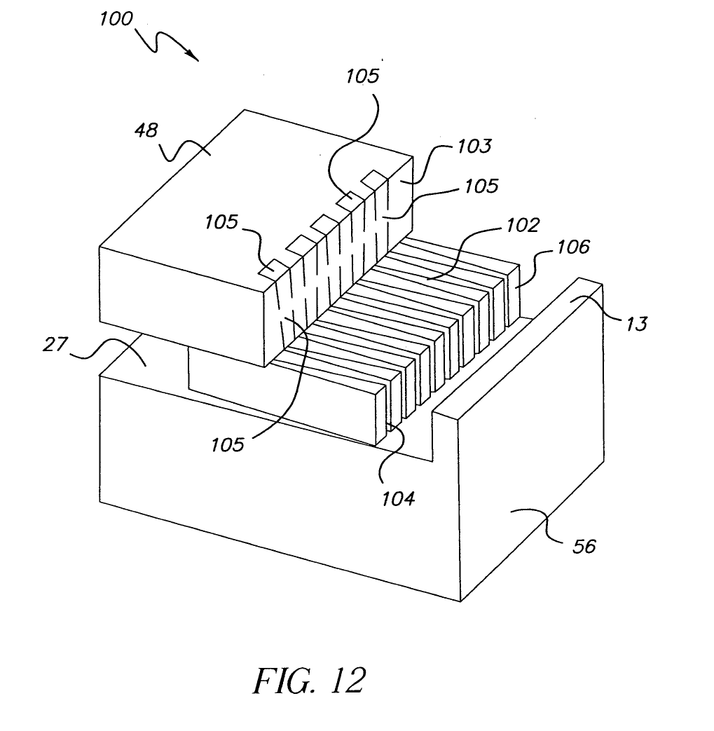

FIGS. 11 and 12 are an embodiment showing gutter 100 in which the gutter is provided with shaped ribs 102 to aid in control of ink flow from the gutter. The ribs 102 are shaped to have narrow openings 104 between the ribs 102 in the end 106 exposed towards wall 12. The narrowness of this flow at 104 aides in increasing suction to the recovery channel as well as capillary flow. Generally, the nozzle array would be located such that drops to be recycled would land adjacent the openings 104 between the ribs 102. Optionally, wall 103 of plate 48 can be provided with one or more groves 105 shaped to guide ink from over deflected non-printed drops toward recovery channel 27. When used, grooves 105 in wall 103 can be between 5 and 25 μm wide, 5 and 25 μm deep, and can extend up to the height of wall 103 of plate 48. Typically, wall 103 is spaced farther away from the ink stream when compared to wall 12.

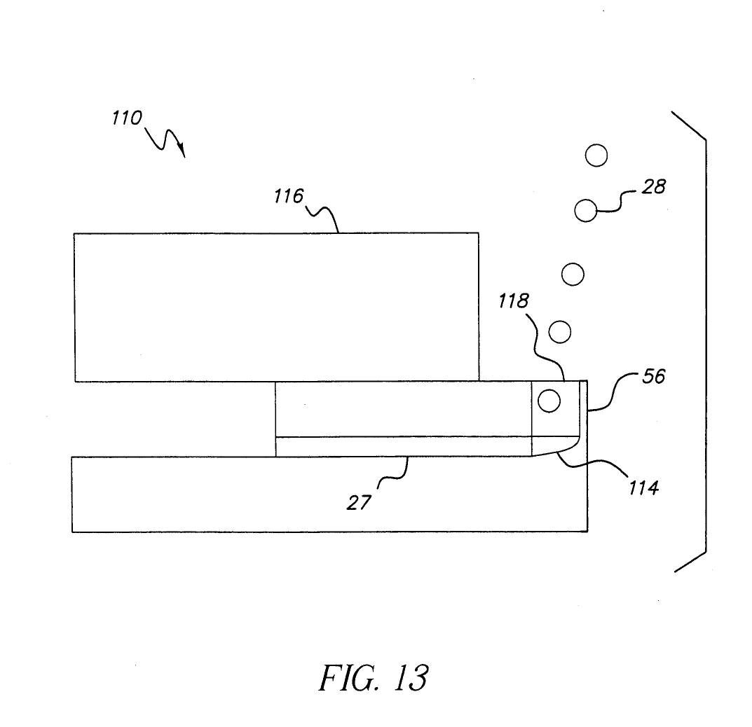

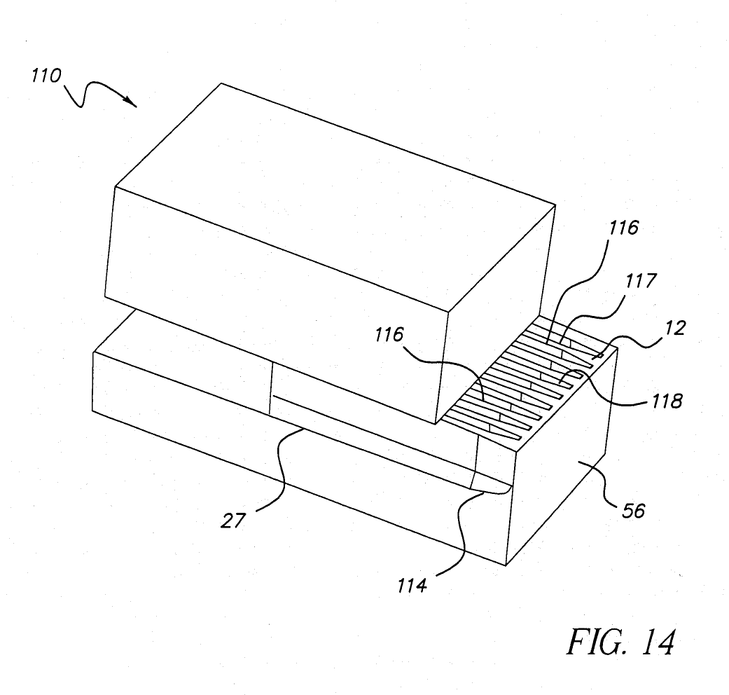

In FIG. 13 and FIG. 14 are shown another embodiment of the invention in which the ribs 116 have been extended so that they are combined with the wall 12. The inkjet orifices will be aligned such that the ink drops removed for recycling will pass into the channel 118 formed where the ribs widen forming the narrow channel 118. There are several advantages to this embodiment of the invention. One advantage is that the narrowing channel 118 has a sloped bottom 114. The slope of the bottom is a function of the deep reactive ion etch (DRIE) formation technique as narrow openings are not etched at as fast a rate as wider openings. Therefore, the channels 117 between the ribs 116 where the ribs 116 are narrower will be deeper and wider than the end in the area 118 where the ribs narrow will not etched is deeply. The advantage is that when inkjet droplets that strike within end channel 118 are gathered they will not be as likely to splatter as they hit the sloped area 114. The elongated narrow area 118 between the ribs 116 also aids in withdrawal of the ink from the area where it is gathered and moves it toward the gutter. The narrowness aids capillary effects and increases the suction in the channel. The portion of the channel in the elongated narrow area has a depth of between 10 and 40% less than the portion of the channel not adjacent to the wall

Grooves placed on the inside or outside of the wall of the invention as well as on the bottom of the gutter may be of any suitable size that will aid in the ink flow preferably provide improved or capillary flow. A preferred size for the grooves at the gutter bottom is a width of between 10 and 50 μm and a depth of between 50 and 300 μm. An optimum size has been found to be between 15 and 25μ in width and 75 to 125μ in gaps for best move of ink to recovery. The grooves in the wall are suitably between 5 and 25 μm in depth and between 5 and 25 μm in width. The preferred ranges are between 5 and 15 μm deep and 5 and 15 μm in width for best ink recovery. The capillary grooves provide a defoaming effect for the ink to be recycled after it reaches the gutter.

The width of the integral wall may be any suitable amount that provides sufficient structural strength. Generally the wall is made as small as possible while retaining structural strength for use in the inkjet head. The wall is generally provided with a width of between 5 and 25 μm and a height of between 100 and 300 μm. The wall extends the length of the monolithic ink jet head which would be from 1 inch to several inches long. A preferred width of the wall would be between about 10 and 20μ wide and between one about 150 and 200μ high as this provides good trapping of ink with the minimum amount of ink hitting the top of the wall, as well as retaining sufficient to structural strength for a long life. The wall and printhead of the invention may be utilized with any type of ink, including both dye and pigment inks.

The invention has been described in detail with particular reference to certain preferred embodiments thereof, but it will be understood that variations and modifications can be effected within the scope of the invention.

### PARTS LIST

9 gutter
10 printhead
12 wall
14 gutter duct
16 gutter
17 gutter
18 nozzle array
22 air duct
24 duct
26 duct opening
27 suction
28 small droplets
32 large droplets
36 nozzle plate
38 plate
42 plate
44 plate
46 plate
48 plate
50 plate
56 wall
58 ink recovery holes
61 printhead
62 main bore
63 bracket
64 notch
68 ribs
70 gutter
72 indentations
74 capillary channels
80 gutter arrangement
82 capillary channels
90 gutter
92 capillary openings
94 chip lines
96 chip lines
98 channels
99 ink returns
100 gutter
102 ribs
104 openings
106 end
110 wafer
111 wafers
112 oxide film
113 wafer
114 wafer
115 wafer
116 photoresist
117 wafer
118 openings
119 printhead
121 manifold
123 opening
125 opening
127 opening
160 printer
161 laminated sub-layers
162 ejection path
164 inlet plenum
166 recovery conduit
168 recording medium
170 gas recycling line
172 print drum
174 vacuum pump
176 gas flow
178 gas flow
210 filter
220 pump
250 silicon wafer

1. An ink jet printhead comprising a monolithic printhead with an integral gutter system wherein said gutter system is provided with an end wall adjacent to the ink stream and wherein the side of the wall adjacent the ink direction is generally parallel to the ink direction through said print head.

2. The ink jet printhead of claim 1 wherein said wall has generally parallel sides and an exposed edge that is exposed toward the ink ejecting orifice of said ink jet printhead.

3. The ink jet printhead of claim 2 wherein said exposed edge is generally perpendicular to the parallel sides of the said wall.

4. The ink jet printhead of claim 1 wherein at least one side of the wall has grooves.

5. The ink jet printhead of claim 4 wherein said grooves are of capillary size.

6. The inkjet printhead of claim 1 wherein grooves having a depth of between about 50 and 300 micrometer and a width of between 10 and 50 micrometer are on the bottom of the gutter adjacent the wall.

7. The inkjet printhead of claim 4 wherein said grooves have a depth of between 5 and 25 μm and a width of between 5 and 25 micrometers.

8. The jet printhead of claim 2 wherein said wall has an exposed edge that is between 5 and 25 μm wide.

9. The inkjet printhead of claim 1 wherein said gutter is provided with at least one orifice in the direction of ink movement through said gutter adjacent to said wall.

10. The inkjet printhead of claim 1 wherein said gutter is separated into a plurality of ink carrying channels by ribs.

11. The inkjet printhead of claim 10 wherein said ribs extend to said wall.

12. The inkjet printhead of claim 11 wherein the channels between said ribs narrow adjacent to said wall.

13. The inkjet printhead of claim 12 wherein said channels are less deep in the narrow portion of the channel adjacent to said wall than in the channel away from the wall.

14. The inkjet printhead of claim 10 wherein said channels have a width of between 10 and 100 micrometers.

15. The inkjet printhead of claim 12 wherein said ink jet printhead has multiple ink jet orifices and the channels are located in the plane of said orifices.

16. The inkjet printhead of claim 12 wherein said ink jet printhead has multiple ink jet orifices and the narrowing channels are located in the plane of said orifices.

17. The ink jet printhead of claim 1 wherein said printhead comprises a monolithic single assembly of silicon micro-machined parts.

18. The inkjet printhead of claim 1 wherein said printhead has multiple ink jet orifices and said wall contains open slots located between the ink streams passing said wall.

19. The inkjet printhead of claim 13 wherein the portion of the channel adjacent to wall is between 10 and 40% less deep than then the portion of the channel not adjacent to the wall.

20. The inkjet printhead of claim 1 where in the grooves are on the outside of the wall towards the droplet exit of the printhead.

21. A method of inkjet printing comprising providing an ink jet printhead comprising at least one orifice for ejection of ink, a gutter system wherein said gutter system is provided with in end wall adjacent to the ink stream and wherein the side of the wall adjacent said ink direction is generally parallel to the ink direction through said print head, ejecting at least one ink jet stream from the printhead, controlling the direction of said at least one ink stream from the orifice by at least one airstream crossing said ink stream such that ink droplets not intended for printing pass into said gutter and droplets intended for printing pass out of the primary claims are in a separate file.

22. The method of claim 21 wherein said wall has generally parallel sides to an exposed edge that is exposed toward the ink ejecting orifice of said ink jet printhead.

23. The method of claim 22 wherein said exposed edge is generally perpendicular to the parallel sides of the said wall.

24. The method of claim 21 wherein at least one side of the wall has grooves.

25. The method of claim 1 wherein grooves having a depth of between about 50 and 300 micrometers and a width of between 10 and 50 micrometers are on the bottom of the gutter adjacent the wall.

26. The method of claim 21 wherein said printhead comprises a monolithic single assembly of silicon micro-machined parts.

27. The method of claim 21 wherein said printhead has multiple ink jet orifices and said wall contains open slots located between the ink streams passing said wall.

28. The inkjet printhead of claim 20 wherein the grooves are in fluid communication with at least one recovery hole located in the gutter system.

29. The inkjet printhead of claim 1 wherein the gutter system includes an additional wall generally parallel to the ink direction through the printhead and spaced apart from the end wall, the additional wall including grooves.
